(19) United States
(12) Patent Application Publication
(10) Pub. No.: US 2009/0119320 A1
(43) Pub. Date: May 7, 2009

(54) METHOD AND SYSTEM FOR ENCODING DATA

(75) Inventors: Douglas E. Welsh, Chandler, AZ (US); Andrea Fossa, Schenectady, NY (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/934,101

(22) Filed: Nov. 2, 2007

(51) Int. Cl. G06F 17/30

(52) U.S. Cl. 707/101; 707/E17.005

(57) ABSTRACT

A method and system for encoding the output data created by a simulator is provided. The method and system may generate smaller output data files or output databases than those created by known techniques. The method and system may also allow for accessing and manipulating the compressed data. The method and system may also significantly increase the speed for manipulating the output data utilizing various calculations.

### BACKGROUND OF THE INVENTION

The present invention relates generally to data compression and, more particularly, to a method and system for encoding data generated during use of a production simulator, or the like.

Production simulation may be considered the computer modeling of the operation of multiple generating units in an electrical power system. Typical simulations determine the commitment (optimal on/off schedule) and the dispatch of the units that are committed “on” in a given time period. The generation dispatch generally determines the optimal level of electricity production for the generating units. Several values derived from the dispatch, i.e. fuel consumption, emission amounts for various pollutants, etc., are also calculated and recorded in production simulation.

The simulated time step for production simulation is typically one hour, although time steps smaller than one hour are also used in practice. The traditional method for recording the simulation results is to write the hourly values for each unit (i.e. megawatt [MW] production, emissions, fuel consumption, etc.), to a file or database as the simulation progresses. The process of recording each individual datum is referred to as “full enumeration”. After the simulation, computer programs are used to retrieve the data generated and stored in the output file or database. These programs may access and manipulate the output for creating reports, exporting of the data to other programs, etc. For an electrical system with 6000 generating units (typical for the large system in the Eastern United States) simulated over a year having 8760 hours, this equates to 52,560,000 hourly values (approx. 210 MB of storage of the “single precision” data types in a file) for the MW data alone. Thus, simulated output files or databases are quite large and unwieldy.

The problems described above may be exacerbated by trends towards deregulation in the electric power industry. Deregulation has created additional markets for ancillary services, beyond those for energy production. These include markets for automatic generation control and regulation. This fact makes it more important to simulate with smaller time steps. If one were to simulate these markets with these reduced time steps, the result is an increase in output data.

There are a few drawbacks with the currently known methods of storing, retrieving, and manipulation these production simulation data. Saving or writing to memory, such as a hard disk or database, slows the operation of the simulation program. These files consume valuable hard disk space. The relatively large simulated output file or database created during the production simulation runs may exceed the hard disk capacity; resulting in a system “crash”. These files or databases are generally too large to read into RAM (memory) and so must be read by sequential access to the disk, which is time consuming. Due to the size of these files or databases, simultaneously inspecting results from multiple simulations of the same time period or for multiple years or other time periods is difficult or impossible. The data are often the same from one time period to the next. By the nature of the calculations routinely performed on the data, this results in redundant calculations being performed, and slowing the process of calculating results.

For the foregoing reasons, there is a need for a method and system to reduce the size of a data file or database generated during a simulation. The method and system create files requiring less hard disk space and reduce the probability of a system crash. The method and system should also allow a simulation system to operate faster than some currently known systems. The method and system should also allow a user to analyze multiple years of simulations (or multiple simulations of the same year) simultaneously. The method and system should also allow a user to access, manipulate, and export the original data, after the data may have been compressed. The method and system should allow for faster manipulation and calculations using the data.

### BRIEF DESCRIPTION OF THE INVENTION

In accordance with an embodiment of the present invention, a method of encoding data generated during at least one simulation conducted on at least one production simulator; the method comprising: providing at least one data encoding system, wherein the at least one data encoding system comprises: at least one database and at least one application program interface (API), and wherein the at least one data encoding system integrates with the at least one production simulator; receiving data from the at least one production simulator, wherein the data is generated during the at least one simulation; utilizing at least one compression tool; wherein the at least one compression tool encodes the data and creates at least one encoded file or at least one compressed database; and wherein the at least one compression tool encodes the data by removing repeated sequences of data and records a binary representation of the repeated sequence of data comprising the number of times each sequence of data is repeated; transmitting the data to the at least one database; and integrating the at least one API with the at least one database; wherein the at least one API formats the data into energy production data.

In accordance with an alternate embodiment of the present invention, a method of encoding data generated during at least one simulation performed on at least one production simulator; the method comprising: providing at least one data encoding system, wherein the at least one data encoding system comprises: at least one database, and at one application program interface (API), and wherein the at least one data encoding system integrates with the at least one production simulator; receiving data into the at least one production simulator, wherein the data is generated during the at least one simulation; utilizing at least one compression tool; wherein the at least one compression tool encodes the data and creates at least one encoded file or at least one compressed database; wherein the at least one compression tool reduces a size of the data to a range of from about 20% to about 10% of an original size of the data; and wherein the at least one compression tool encodes the data by removing repeated sequences of data and records a binary representation of the repeated sequence of data comprising the number of times each sequence of data is repeated; transmitting the data to the at least one database; and integrating the at least one API with the at least one database; wherein the at least one API formats the data into energy production data and generates at least one report; wherein the at least one data encoding system allows for manipulation of the at least one encoded file; wherein the manipulation comprises mathematical operations, and combinations thereof.

In accordance with a second alternate embodiment of the present invention, a system for encoding data generated during at least one simulation performed on at least one production simulator; the system comprising: at least one data encoding system, wherein the at least one data encoding system comprises: at least one database, and at one application program interface (API), and wherein the at least one data encoding system integrates with the at least one production simulator; data generated by the at least one production simulator; at least one compression tool; wherein the at least one compression tool encodes the data and creates at least one encoded file or at least one compressed database; wherein the at least one compression tool reduces a size of the data to a range of from about 20% to about 10% of an original size of the data; and wherein the at least one compression tool encodes the data by removing repeated sequences of data and records a binary representation of the repeated sequence of data comprising the number of times each sequence of data is repeated; means for transmitting the data to the at least one database; means for integrating the at least one API with the at least one database; means for determining whether at least one user application will utilize the data; and wherein the at least one data encoding system allows for manipulation of the at least one encoded file; wherein the manipulation comprises mathematical operations, and combinations thereof.

### BRIEF DESCRIPTION OF THE DRAWINGS

FIG. 1 is a schematic illustrating the environment in which an embodiment of the present invention operates.

FIG. 2 is a flow chart illustrating a method of compressing data in accordance with an embodiment of the present invention.

FIG. 3 is a block diagram of an exemplary system for compressing data in accordance with an embodiment of the present invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

An embodiment of the present invention takes the form of an application and process that has the technical effect of reducing the size of a file needed to store the data generated during a simulation by compressing the generated data. The application and process may also have the technical effect of allowing for faster access to and manipulation of the compressed data file. An embodiment of the present invention may store the output data from the simulation in a smaller file size without loss of information.

Full enumeration may be considered the process of recording each individual datum generated during a simulation. The present invention may reduce the amount of data by identifying sequentially redundant items in the fully-enumerated data (i.e. a sequence of ten zeros) and replacing that data with a single datum for the repeated value and a record of how many times the datum occurs in sequence.

The present invention may provide a method and system for encoding the output data created during a simulation, such as, by not limiting of, electricity production simulation. An output of the present invention may include encoded files significantly smaller than files created in known manners. An embodiment of the present invention, as described below, may be used for the encoding and analysis of production simulation data, and may also be used generally with time-series data containing redundant information. An embodiment of the present invention may also allow for efficient manipulations, such as, but not limiting of, on both the input data (compressed in like manner to the output data) and output data (compressed, encoded, or the like), to generate reports, or the like. The present invention may also perform calculations in less time and require fewer numbers of floating point operations (FLOPS).

The present invention provides the benefit of decreasing the overall processing time of a simulation. This includes significantly increasing the speed of accessing the data generated by the simulation. This also includes increasing the speed of performing calculations on the data. For example, but not limiting of, a user may experience speed increases in the multiples of 5×-300×, depending on the data.

The present invention may allow for mathematical manipulation of the encoded data. Previously, there may not be a means for performing mathematical operations on fully enumerated data that does not involve accessing each individual data point from the uncompressed data. The time required to perform a calculation generally increases with the amount of data read from the file and the number FLOPs.

For example, but not limiting of, the revenue of a generating unit is the sum of the product of hourly generation (MWh) values and price. For a five-hour period in which the generating unit is operating at 800 MW for all hours, and the spot price was $40.23, $41.65, $65.19, $32.99 and $75.12 in hours 1-5, respectively, the revenue would be (800*$40.23)+($800*$41.65)+(800*$65.19)+(800*$32.19)+(800*$75.12)=$203,504.00. Here, the computational engine may have to access ten items from a file saved on the hard disk. Each multiplication and addition operation represents one FLOP, so here one would have five FLOPs from multiplication and five FLOPs from addition, or a total of ten FLOPs.

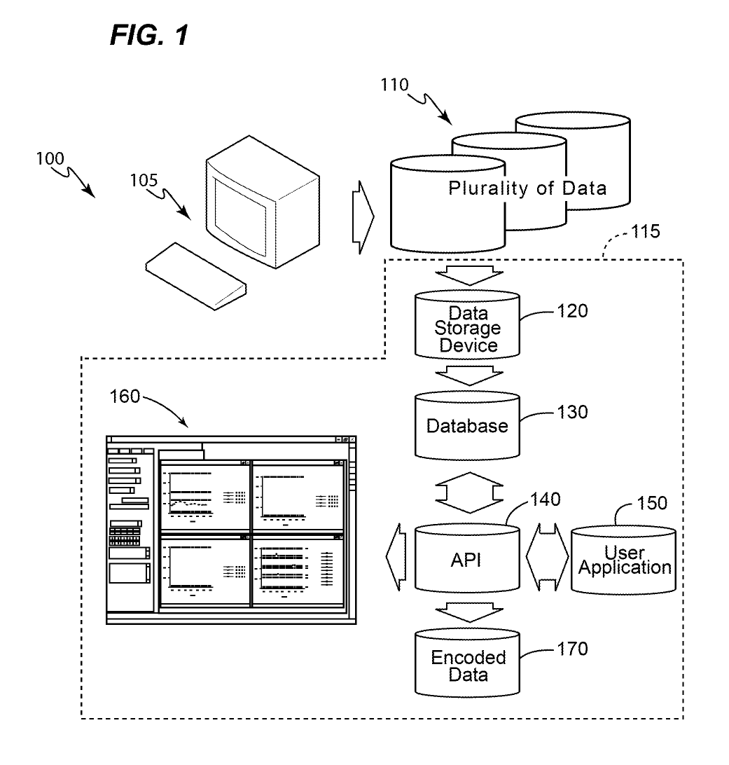

Data generated during a production simulation, commonly includes a particular simulated variable having the same value over a time range. For example, but not limiting of, a simulated generating unit may operate at 150 MW in hour one, 150 MW in hour two, and so on, through hour 500. In a fully enumerated file or database, this would be represented by a sequence of 500 binary representations of the number 150. Typically, the value for the number 150 would be stored as a ‘single’ data type, with a length of 4 bytes (32 bits). Hence the amount of disk space required for these data is 4*500 bytes=2000 bytes. In an embodiment of the present invention, a data encoding system 105 (as illustrated in FIG. 1) may record the binary representations for only the repeated value in the sequence (150), plus the number of times it occurs in sequence (500). This would require only 2*4 bytes=8 bytes, a reduction in file size of 99.6% in this example. The encoding method in this case may require a modest amount of memory, the addition of an index into the encoded data.

For the case where three units are being simulated, the encoded file or database may have an array of hourly MW production values such as the following.

TABLE 1
Simulation Data

| | | Start Hour | Value |
|---|---|---|---|
| | | 1 | 50 |
| | | 900 | 0 |
| Encoded data | {open oversize brace} | 1300 | 75 |
| for Unit 1 | | 6800 | 0 |
| | | 7100 | 50 |
| | | 1 | 20 |
| Encoded data | | 1200 | 25 |
| for Unit 2 | {open oversize brace} | 1500 | 40 |
| | | 4500 | 30 |
| | | 1 | 50 |
| | | 900 | 0 |
| Encoded data | | 1300 | 75 |
| for Unit 3 | {open oversize brace} | 6800 | 0 |
| | | 7100 | 50 |
| | | 8500 | 35 |

Index
1 <- Data for the first unit starts with the first element in the set
6 <- Data for the second unit starts with the sixth element in the set
10 <- Data for the third unit starts with the tenth element in the set

The encoded simulation data may not need at least one record for the last hour of the simulation period (i.e. Unit 1 in the Table 1 does not require a record to show that the level of 50 MW started in hour 7100 ends at the end of the year in hour 8760). The end period may be inferred from information stored elsewhere in the dataset relating to the last hour of the year, the time at which the unit is retired from service, etc.

TABLE 2
Simulation Data

| | | Start Hour | End Hour | Value |
|---|---|---|---|---|
| | | 1 | 899 | 50 |
| | | 900 | 1299 | 0 |
| Encoded data | {open oversize brace} | 1300 | 6799 | 75 |
| for Unit 1 | | 6800 | 7099 | 0 |
| | | 7100 | 8760 | 50 |
| | | 1 | 1199 | 20 |
| Encoded data | | 1200 | 1499 | 25 |
| for Unit 2 | {open oversize brace} | 1500 | 4499 | 40 |
| | | 4500 | 8760 | 30 |
| | | 1 | 899 | 50 |
| | | 900 | 1299 | 0 |
| Encoded data | | 1300 | 6799 | 75 |
| for Unit 3 | {open oversize brace} | 6800 | 7099 | 0 |
| | | 7100 | 8499 | 50 |
| | | 8500 | 8760 | 35 |

The method for performing calculations on the encoded data may require a minor expansion of the data. As shown in Table 2, an extra column may be added (within the data encoding system 105, but not in the disk file or database). This column represents the last hour in which the sequence of values is consistent.

Another example, but not limiting of, the present invention involves the case where one wants to calculate total energy production for a unit over the year. Here, the formula is: Z(End Hour−Start Hour+1)*Value; across all the records for the given unit. In the case of Unit 1, this is

$$( 899 - 1 + 1 ) * 50 + ( 1299 - 900 + 1 ) * 0 + ( 6799 - 1300 + 1 ) * 0 + ( 7099 - 6800 + 1 ) * 0 + ( 8760 - 7100 + 1 ) * 50 = 540 , 500 MWh$$

Note that the FLOP count in this case is 25, versus the 8760 one would have in the fully enumerated case, and the disk access would similarly be reduced.

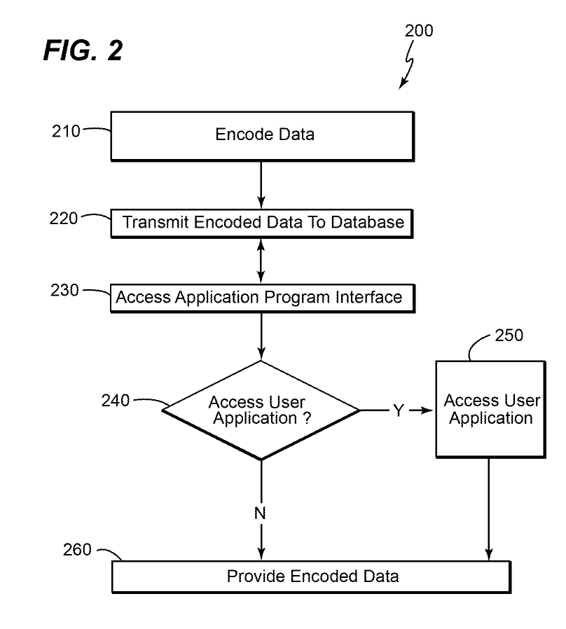

The calculations are similar when determining the revenue of the generating unit over the course of the year, except the final summation. Then the 8760 hourly electricity prices available to the unit are summed corresponding to the Start Hour/End Hour breakdowns in Table 2. (e.g. one calculates five intermediate sums for hours 1-899, 900-1299, 1300-6799, 6800-7099, and 7100-8760). The revenue is then the sum of the dot product of the row calculations from FIG. 2 times the intermediate sums. For the sample Unit 1, this would amount to 8,770 FLOP, approximately a 50% reduction from the fully enumerated case.

The aforementioned examples may provide the general methods by which the encoded data may be created and manipulated significantly faster than fully enumerated data.

Referring now to the Figures, where the various numbers represent like elements throughout the several views. FIG. 1 is a schematic illustrating the environment in which an embodiment of the present invention operates. FIG. 1 illustrates an overview of some of the software and hardware components that may collectively be used on a location 100 for production simulation; data compression (hereinafter “encoding”, or the like); and manipulation, in accordance with an embodiment of the present invention may be used. Moreover, FIG. 1 is by way of example and may not illustrate all of the various components and/or auxiliaries that may be required to perform the aforementioned operations.

A production simulator 105 may generate a plurality of data (hereinafter “data”) 110, which may be transmitted to a data encoding system 115 for performing the general methods of encoding and manipulating data, as described above. The data encoding system 115 may be integrated with at least one production simulator 105.

The data encoding system 115 may include at least one data compression tool 120, at least one database 130, and at least one application program interface (API) 140. The at least one data compression tool 120 may encode the data 110 resulting in a data compression resulting in a reduction in size of the original file size of from about 20% to about 10% of the original size. The API 140 may have access to the database 130 and allows for the generation of at least one report 160, or the like. An embodiment of the present invention may allow for a user application 150 to be integrated with the API 140, allowing a user to access and utilize the encoded data 170.

The data encoding system 115 may also provide the encoded data 170 in a medium allowing for storage onto a hard drive, in a database, or the like. In an alternate embodiment of the present invention at least one data encoding system 115 comprises at least of a one master input file and at least one of a control file for guiding operation of the production simulator, and combination thereof.

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium.

Any suitable computer readable medium may be utilized. The computer-usable or computer-readable medium maybe, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. Further the computer program code for carrying out operations of the present invention may also be written in higher level languages, such as “Matlab”, or a similar programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block.

FIG. 2 is a flow chart illustrating a method 200 of encoding data in accordance with an embodiment of the present invention. The method 200 may execute the steps that may be used by the data encoding system 115.

In step 210 a production simulator 105 may encode the data 110, generated by the at least one production simulator 105 during a simulation run. In an embodiment of the present invention the data encoding system 115 may be integrated with a production simulator 105. In an embodiment of the present invention at least data compression tool 120 may be used to encode the data 110, as discussed. In an alternate embodiment of the present invention, a plurality of data compression tools 120 may be used. For example, but not limiting of, a first data compression tool 120 may be used to compress the data 110 to about 20% of the original size. Next, a second data compression tool using different methods than those used in this invention, for example WinZip or PKZip or the like 120 may be used to compress the data 110 to about 12% of the original size.

In step 220, the method 200 transmits the data 110 to at least one database 130. The at least one database 130 comprising at least one graphical user interface, wherein the at least one graphical user interface allows for inspecting the data 110 in either a compressed or an uncompressed form. The at least one database 130 may allow for portability to a Windows and/or Linux, and/or Unix or other similar platform. The at least one database 130 may be integrated into a standard language for querying (SQL, or the like) relational databases.

In an embodiment of the present invention, the method 200 may automatically transmit the data 110 to the at least one database 130. In an alternate embodiment of the present invention, the method 200 may provide a graphical user interface, or the like, allowing the user to manually commence transmitting of the data 1 10 to the at least one database 130.

In step 230, the method 200 may access the API 140. As discussed the API 140 may generate at least one report 160 on the data 110, which has been encoded. The report 160 may, for example, but not limiting of, include results from the mathematical manipulation of the encoded data 170. In an embodiment of the present invention, the user may define the content of the at least one report 160. In an alternate embodiment of the present invention, the content of the at least one report may be predefined by the supplier of the data encoding system 115.

In step 240, the method 200 may determine whether to access at least one user application 150. As discussed, a user may desire to access, import, or the like, into a separate application the encoded data 170. If a user application 150 is to be accessed, then the method may proceed to step 250; otherwise the method 200 may proceed to step 260.

In step 250, the method 200 may access at least one user application 150. As discussed, the at least one user application 150 may allow a user to build custom reports, or the like. In an embodiment of the present invention, the API 140 may be integrated with the at least one user application 150, which may be written in for example, but not limiting of, JAVA, C, Visual Basic, Matlab, Access, or other languages.

In step 260, the method 200 may provide the encoded data 170 in medium allowing for storage or other uses, as discussed. In an embodiment of the present invention a file format of the at least one encoded file comprises at least one of: a comma separate variable (.csv), an EXCEL (.xls), a text (.txt), a Matlab (.mat), an Access (.mdb), a Hierarchical Data Format (.h5 or .hdf); and combinations thereof.

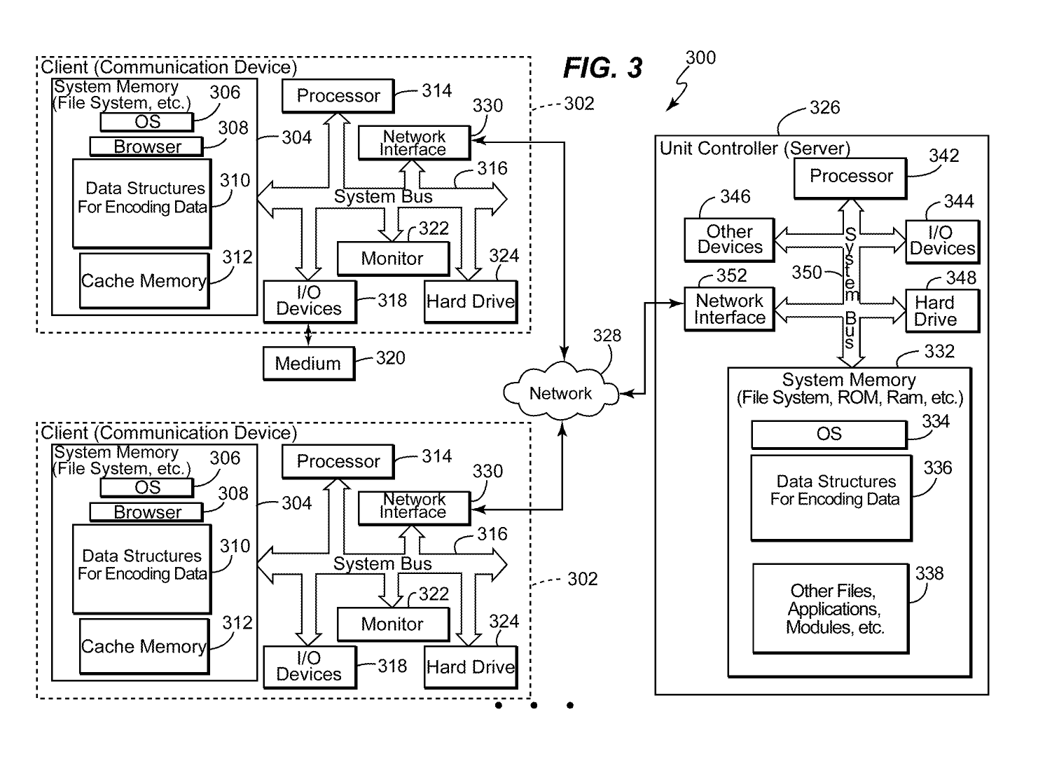

FIG. 3 is a block diagram of an exemplary system 300 for encoding data in accordance with an embodiment of the present invention. The elements of the method 200 may be embodied in and performed by the system 300. The system 300 may include one or more user or client communication devices 302 or similar systems or devices (two are illustrated in FIG. 3). Each communication device 302 may be for example, but not limited to, a computer system, a personal digital assistant, a cellular phone, or similar device capable of sending and receiving an electronic message.

The communication device 302 may include a system memory 304 or local file system. The system memory 304 may include for example, but is not limited to, a read only memory (ROM) and a random access memory (RAM). The ROM may include a basic input/output system (BIOS). The BIOS may contain basic routines that help to transfer information between elements or components of the communication device 302. The system memory 304 may contain an operating system 306 to control overall operation of the communication device 302. The system memory 304 may also include a browser 308 or web browser. The system memory 304 may also include data structures 310 or computer-executable code for encoding data that may be similar or include elements of the method 200 in FIG. 2.

The system memory 304 may further include a template cache memory 312, which may be used in conjunction with the method 200 in FIG. 2 for encoding data.

The communication device 302 may also include a processor or processing unit 314 to control operations of the other components of the communication device 302. The operating system 306, browser 308, and data structures 310 may be operable on the processing unit 314. The processing unit 314 may be coupled to the memory system 304 and other components of the communication device 302 by a system bus 316.

The communication device 302 may also include multiple input devices (I/O), output devices or combination input/output devices 318. Each input/output device 318 may be coupled to the system bus 316 by an input/output interface (not shown in FIG. 3). The input and output devices or combination I/O devices 318 permit a user to operate and interface with the communication device 302 and to control operation of the browser 308 and data structures 310 to access, operate and control the software to encode data. The I/O devices 318 may include a keyboard and computer pointing device or the like to perform the operations discussed herein.

The I/O devices 318 may also include for example, but are not limited to, disk drives, optical, mechanical, magnetic, or infrared input/output devices, modems or the like. The I/O devices 318 may be used to access a storage medium 320. The medium 320 may contain, store, communicate, or transport computer-readable or computer-executable instructions or other information for use by or in connection with a system, such as the communication devices 302.

The communication device 302 may also include or be connected to other devices, such as a display or monitor 322. The monitor 322 may permit the user to interface with the communication device 302.

The communication device 302 may also include a hard drive 324. The hard drive 324 may be coupled to the system bus 316 by a hard drive interface (not shown in FIG. 3). The hard drive 324 may also form part of the local file system or system memory 304. Programs, software, and data may be transferred and exchanged between the system memory 304 and the hard drive 324 for operation of the communication device 302.

The communication device 302 may communicate with a server 326 and may access other servers or other communication devices similar to communication device 302 via a network 328. The system bus 316 may be coupled to the network 328 by a network interface 330. The network interface 330 may be a modem, Ethernet card, router, gateway, or the like for coupling to the network 328. The coupling may be a wired or wireless connection. The network 328 may be the Internet, private network, an intranet, or the like.

The server 326 may also include a system memory 332 that may include a file system, ROM, RAM, and the like. The system memory 332 may include an operating system 334 similar to operating system 306 in communication devices 302. The system memory 332 may also include data structures 336 for encoding data. The data structures 336 may include operations similar to those described with respect to the method 200 for encoding data. The server system memory 332 may also include other files 338, applications, modules, and the like.

The server 326 may also include a processor 342 or a processing unit to control operation of other devices in the server 326. The server 326 may also include I/O device 344. The I/O devices 344 may be similar to I/O devices 318 of communication devices 302. The server 326 may further include other devices 346, such as a monitor or the like to provide an interface along with the I/O devices 344 to the server 326. The server 326 may also include a hard disk drive 348. A system bus 350 may connect the different components of the server 326. A network interface 352 may couple the server 326 to the network 328 via the system bus 350.

The flowcharts and step diagrams in the figures illustrate the architecture, functionality, and operation of possible implementations of systems, methods, and computer program products according to various embodiments of the present invention. In this regard, each step in the flowchart or step diagrams may represent a module, segment, or portion of code, which comprises one or more executable instructions for implementing the specified logical functions). It should also be noted that, in some alternative implementations, the functions noted in the step may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of encoding data generated during at least one simulation conducted on at least one production simulator; the method comprising:
providing at least one data encoding system, wherein the at least one data encoding system comprises: at least one database and at least one application program interface (API), and wherein the at least one data encoding system integrates with the at least one production simulator;
receiving data from the at least one production simulator, wherein the data is generated during the at least one simulation;
utilizing at least one compression tool; wherein the at least one compression tool encodes the data and creates at least one encoded file or at least one compressed database; and wherein the at least one compression tool encodes the data by removing repeated sequences of data and records a binary representation of the repeated sequence of data comprising the number of times each sequence of data is repeated;
transmitting the data to the at least one database; and
integrating the at least one API with the at least one database; wherein the at least one API formats the data into energy production data.

2. The method of claim 1 wherein the at least one data encoding system allows for manipulation of the at least one encoded file; wherein the manipulation comprises mathematical operations, and combinations thereof.

3. The method of claim 1, wherein the API allows for access to each of the data, wherein the data comprises the unencoded and the encoded data.

4. The method of claim 1, wherein the step of utilizing at least one compression tool reduces a size of the data to a range of from about 20% to about 10% of an original size of the data.

5. The method of claim 1, wherein the API generates at least one report.

6. The method of claim 1, the at least one database comprising at least one graphical user interface, wherein the at least one graphical user interface allows for inspecting the unencoded and the encoded data.

7. The method of claim 1, wherein a file format of the at least one encoded file comprises at least one of: a comma separate variable (.csv), an EXCEL (.xls), a text (.txt), a Matlab (.mat), a Hierarchical Data Format (.h5 or .hdf); and combinations thereof.

8. The method of claim 1, wherein the at least one data encoding system comprises at least of a one master input file and a control file, and combinations thereof.

9. The method of claim 1 further comprising: determining whether at least one user application will utilize the data.

10. A method of encoding data generated during at least one simulation performed on at least one production simulator; the method comprising:
providing at least one data encoding system, wherein the at least one data encoding system comprises: at least one database, and at one application program interface (API), and wherein the at least one data encoding system integrates with the at least one production simulator;
receiving data into the at least one production simulator, wherein the data is generated during the at least one simulation;
utilizing at least one compression tool; wherein the at least one compression tool encodes the data and creates at least one encoded file or at least one compressed database; wherein the at least one compression tool reduces a size of the data to a range of from about 20% to about 10% of an original size of the data; and wherein the at least one compression tool encodes the data by removing repeated sequences of data and records a binary representation of the repeated sequence of data comprising the number of times each sequence of data is repeated;
transmitting the data to the at least one database; and
integrating the at least one API with the at least one database; wherein the at least one API formats the data into energy production data and generates at least one report;
wherein the at least one data encoding system allows for manipulation of the at least one encoded file; wherein the manipulation comprises mathematical operations, and combinations thereof.

11. The method of claim 10, wherein the at least one API allows for access to each of the data, wherein the data comprises the unencoded and the encoded data.

12. The method of claim 10, wherein the at least one database comprising at least one graphical user interface, wherein the at least one graphical user interface allows for inspecting the unencoded and the encoded data.

13. The method of claim 10, wherein a file format of the at least one encoded file comprises at least one of: a comma separate variable (.csv), an EXCEL (.xls), a text (.txt), a Matlab (.mat), an Access (.mdb), a Hierarchical Data Format (.h5 or .hdf); and combinations thereof.

14. The method of claim 10, wherein the at least one data encoding system comprises at least of a one master input file and a control file, and combinations thereof.

15. The method of claim 10 further comprising: determining whether at least one user application will utilize the data.

16. A system for encoding data generated during at least one simulation performed on at least one production simulator; the system comprising:
at least one data encoding system, wherein the at least one data encoding system comprises: at least one database, and at one application program interface (API), and wherein the at least one data encoding system integrates with the at least one production simulator;
data generated by the at least one production simulator;
at least one compression tool; wherein the at least one compression tool encodes the data and creates at least one encoded file or at least one compressed database;
wherein the at least one compression tool reduces a size of the data to a range of from about 20% to about 10% of an original size of the data; and wherein the at least one compression tool encodes the data by removing repeated sequences of data and records a binary representation of the repeated sequence of data comprising the number of times each sequence of data is repeated;
means for transmitting the data to the at least one database;
means for integrating the at least one API with the at least one database;
means for determining whether at least one user application will utilize the data; and
wherein the at least one data encoding system allows for manipulation of the at least one encoded file; wherein the manipulation comprises mathematical operations, and combinations thereof.

17. The system of claim 16, wherein the API allows for access to each of the data, wherein the data comprises the unencoded and the encoded data.

18. The system of claim 16, wherein the at least one database comprises at least one graphical user interface, wherein the at least one graphical user interface allows for inspecting the unencoded and the encoded data.

19. The system of claim 16, wherein the at least one encoded file comprises a file format comprising at least one of: a comma separate variable (.csv), an EXCEL (.xls), a text (.txt), a Matlab (.mat), an Access, (.mdb) a Hierarchical Data Format (.h5 or .hdf); and combinations thereof.

20. The system of claim 16, wherein the at least one API formats the data into energy production data; and wherein the API generates at least one report.
